(19) United States
(12) Patent Application Publication
(10) Pub. No.: US 2015/0001820 A1
(43) Pub. Date: Jan. 1, 2015

(54) HAULER APPARATUS

(71) Applicant: Anthony Cormier, Garden Grove, CA (US)

(72) Inventor: Anthony Cormier, Garden Grove, CA (US)

(21) Appl. No.: 13/930,136

(22) Filed: Jun. 28, 2013

(51) Int. Cl. B62B 1/22

(52) U.S. Cl. CPC B62B 1/22
USPC 280/47.26

(57) ABSTRACT

A hauler apparatus transports a five gallon bucket from one location to another without the use of manual hauling which would result in a more efficient means of transporting various materials. The apparatus may include a frame, a vertical support, a handle, a rod base, a forward foot, an axle, a holder, a wheel, and a securement strap.

### FIELD OF THE INVENTION

The present invention relates to transporting objects, and more particularly to a dolly hauling buckets.

### BACKGROUND OF THE INVENTION

People use dollies to transport heavy items from one location to another. Sometimes, due to the nature of the item being hauled requires a five gallon bucket. For example, a container would be needed to transport liquids such as water. Other times a container is needed just for the convenience of transporting several items at once.

There exists a need for an inexpensive way to transport objects from one location to another. Also, there exists a need to transport a container that is secure and stable without the associated problems.

### SUMMARY OF THE INVENTION

The present invention addresses the above stated need by providing an inexpensive, attachment apparatus which provides a user to transport objects from one location to another. The attachment apparatus includes a frame, a vertical support, a handle, a rod base, a forward foot, an axle, a holder, a wheel, and a securement strap. The objects that needs to be transported from one location to another is placed inside of a five gallon bucket. That bucket is then securely placed in the hauler apparatus. Then the user transports the object from one location to another in an efficient manner.

It is an object of the invention to provide an inexpensive, device that transports the object from one location to another. The object may be paint, cement, dirt, water, gardening supplies, and construction tools.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a hauler apparatus according to at least one aspect of the invention.

FIG. 2 is a side view of FIG. 1 of the hauler apparatus.

FIG. 3 is a front view of FIG. 1 of the hauler apparatus.

FIG. 4 is a top view of FIG. 1 of the hauler apparatus.

FIG. 5A is a semi-circular handle of the hauler apparatus.

FIG. 5B is a straight handle of the hauler apparatus.

### DETAILED DESCRIPTION

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

Reference will now be made in detail to various exemplary embodiments of the invention. The following detailed description is presented for the purpose of describing certain embodiments in detail. The present invention may be further illustrated in the following figures, attention being called to the fact, however, that the embodiments described in the description and shown in the figures are illustrative only and are not intended to limit the scope of the invention, and that changes may be made in the specific constructions described in this specification and accompanying drawings that a person of ordinary skill in the art will recognize are within the scope and spirit of the invention. The true scope of the invention is defined by the claims. Further, any features of any embodiment described herein are equally applicable to any other embodiment described herein or envisioned by one of ordinary skill in the art. The detailed description and figures provided herein should not be construed to exclude features otherwise described with respect to another embodiment.

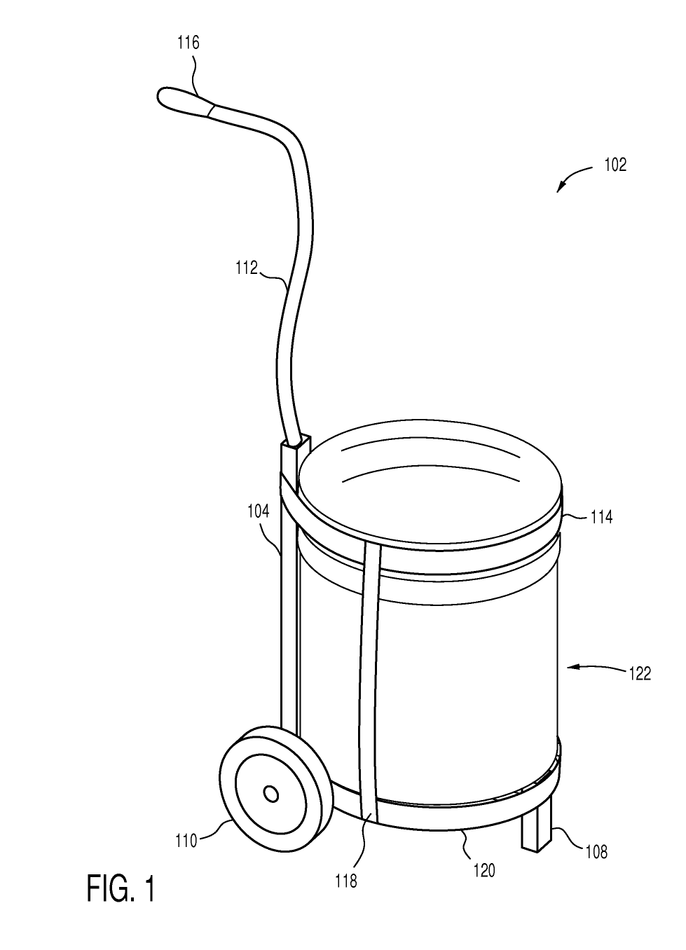

Referring now to FIG. 1, a hauler apparatus 102 is depicted. The apparatus 102 may include a frame 120, a vertical support 104, a handle 116, a rod base 112, a forward foot 108, an axle 202, a holder 114, a wheel 110, and a securement strap 118. The different elements and components of the hauler apparatus 102 may transport an object from one location to another. As a non-limiting example, the object may be a five gallon bucket 122.

The frame 120 has a first end, second end and a center. The five gallon bucket 122 may be secured to the frame. The vertical support 104 has a first end and second end. The second end of the frame is operably connected to second end of the vertical support. As a non-limiting example, operably connected may be defined as connected by the use of bolts, screws, pins, or any other mechanism which allows the hauler apparatus 102 to operate. As a non-limiting example, the frame 120 may be connected to the vertical support 104 by a long pole that may double as the axle 202 which in turn is connected to the wheel 110. Moreover, the frame 120 may engage the axle 202 by the use of screws or by the frame 120 have a predetermined slot whereby the axle 202 may be placed through.

The wheel 110 may be connected to the axle by the use of a screw and bolts and may contain ball bearings within the wheel 110. As a non-limiting example, the wheel may be a tire or coated with a friction surface such as rubber with treads. Also, there may be an axle 202 on each side of the hauler apparatus 102. This allows a wheel 110 to be attached to the hauler apparatus 102 on each side and thereby providing a means for the hauler apparatus 102 to be wheeled.

As a non-limiting example, the wheel may absorb shock by the use of a suspension mechanism or the material properties of the wheel. As such, when the hauler apparatus 102 is being used to transport an object, it maybe experience rough terrain. This may make the transportation more difficult because it would shift the object in an uncontrollable manner. By using shock absorbing properties, the wheel would provide a smoother transportation of the object.

The rod base 112 has a first end and a second end. The second end of the rod base 112 may be connected to the first end of the vertical support 104. This allows the user to engage the frame 120 and thereby move the hauler apparatus 102. As a non-limiting example, the rod base 112 may be a plane, a rectangular shaped piece, or a oval shaped piece. Moreover, as another non-limiting example, the rod base 112 may be curved in a manner to ergonomically suit the user. As a non-limiting example, the rod base 112 may be adjustable in length according to the user's specifications or needs.

The handle 116 has a first end and a second end. The second end of the handle 116 is farthest away from the user. As a non-limiting example, the handle may a simple rubber grip that may be slid on or it may be a semi-circle horizontal grip.

The second end of the handle 116 is connected to the first end of the base rod 112. The handle 116 and the base rod 112 may be connected by a slid on grip that is attached by some sort of adhesive or it may just be tight enough to stretch over the rod base 112.

The forward foot 108 may be connected to the first end of the frame 120. The forward foot 108 is used when the hauler apparatus 102 is at rest and the weight of the object such as a five gallon bucket 118 is distributed between the wheels 110 and forward foot 108. As a non-limiting example, the forward foot 108 may be a varied length piece of plastic, metal, or rubber. As a non-limiting example, the forward foot 108 may have a coating or a friction point to stabilize the hauler apparatus 102 with the ground.

The holder 114 is used to stabilize the top portion of the object during transportation process. The holder 114 may be a loop. As a non-limiting example, the holder 114 may be a metal loop, a rubber belt that is adjustable, or a plastic shape. The first end of the vertical support 104 is connected to the holder 114. By placing the holder 114 at the first end of the vertical support 104, this allows the hauler apparatus 102 to secure the top portion of the object. As a non-limiting example, if a five gallon bucket 122 is the object, then the top half of the bucket would be securely attached by stabilizing the top portion.

The securement strap 118 may be located at the center of the frame 120. The securement strap may be connected to the center of the frame by the use of a screw on opposite side of the frame. As non-limiting examples, the securement strap 118 may be a rubber belt, a synthetic material that is flexible, or a nylon strap. Moreover, as a non-limiting example, the securement strap 118 may be adjustable in length. It may have predefined holes wherein there may be a hook that is inserted in the hole to secure the object. Once the object is secured to the hauler apparatus 102, the object is stabilized and attached to the hauler apparatus 102 to prevent the object from falling over the hauler apparatus 102 during transportation.

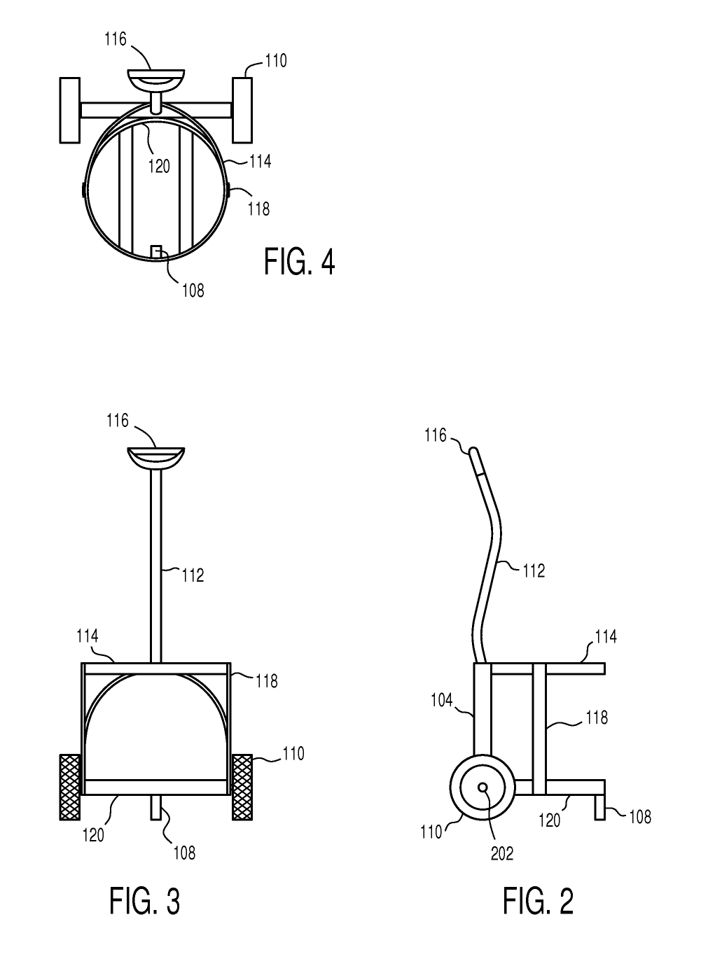

As seen in FIG. 2, the hauler apparatus 102 is at rest. The forward foot is engaged equally with the wheels 110. The rod base 112 shows how it may be a curved pole. By using a curved pole, the hauler apparatus 102 would be ergonomically shaped to ease the effort needed to transport the object.

As seen in FIG. 3, the forward foot 108 engages the ground when at rest. The forward foot 108 acts as a friction point which prevents the hauler apparatus 102 from slipping or rolling when at rest. As a non-limiting example, the friction point may be the forward foot 108 itself or it may be coated with a material to enhance the friction.

As seen in FIG. 4, the securement strap 118 is used to attach the object to the frame 120. As a non-limiting example, there may be two securement straps 118 to stabilize the object further. This would be useful when hauling that that has a tendency to move during transportation such as water.

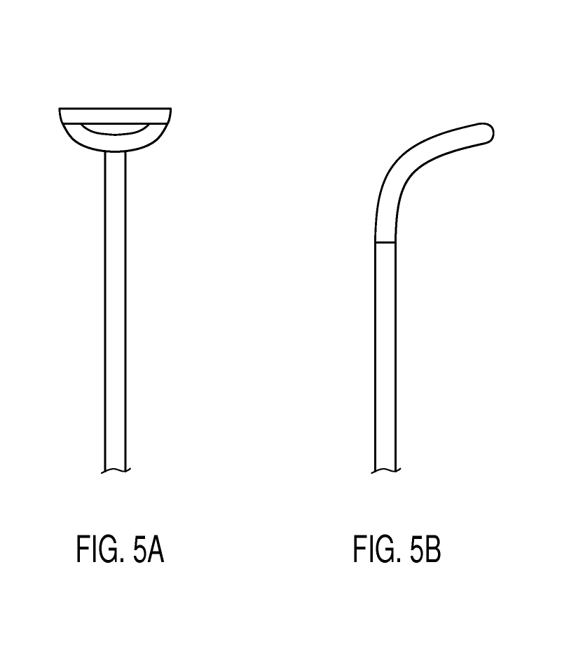

As seen in FIGS. 5 A and 5 B, the handle 116 may be ergonomically shaped. As a non-limiting example, the handle 116, may be made of metal, steel, plastic, wood, or rubber. FIG. 5 A shows a semi-circle horizontal grip as a non-limiting variation. FIG. 5 B shows another non-limiting variation of the handle 116 as a rubber grip in a straight fashion.

The user would place the object, as a non-limiting example a five gallon bucket 122, on the frame 120. Once it is secured to the hauler apparatus 102 by the holder 114 and the securement strap 118, the object is ready to be transported. The user will then tilt the hauler apparatus 102 and then and push in the desired direction without the use of manual hauling. This will result in less back strain and more efficient means of transporting various materials. As non-limiting examples, the various materials may include paint, cement, dirt, water, gardening supplies, construction tools, and other items that need to be hauled. The preferred embodiment is to haul a five gallon bucket 122 and the whatever may be placed inside.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A hauler device for transporting an object from one location to another, the device comprising:
a frame which has a first end, second end, and a center;
a vertical support which has a first end and a second end;
a handle which has a first end and a second end;
a rod base which has a first end and a second end wherein said second end operably connects to said first end of said vertical support; wherein second end of said handle is operably connected to said first end of said base rod;
a forward foot which the hauler rests upon when not in motion;
an axle that engages said frame;
a holder that retains said object;
a wheel that is connect to each said axle; and
a securement strap.

2. The device of claim 1 wherein said second end of said frame is operably connected to said second end of said vertical support.

3. The device of claim 1 wherein said first end of said vertical support is operably connected to said holder.

4. The device of claim 1 wherein said holder is a loop.

5. The device of claim 1 wherein said rod base is a curved pole.

6. The device of claim 1 wherein said handle is ergonomically shaped.

7. The device of claim 1 wherein said forward foot is operably connected to said first end of said frame.

8. The device of claim 1 wherein said forward foot further comprises a friction point which prevents the device from slipping when at rest.

9. The device of claim 1 wherein said axle engages the second end of said vertical support and second end of said frame.

10. The device of claim 1 wherein said wheel absorbs shock.

11. The device of claim 1 wherein said securement strap is operably connected to center of said frame.

12. The device of claim 1 wherein said securement strap is adjustable in length to secure the said object.
